(19) United States
(12) Patent Application Publication
(10) Pub. No.: US 2011/0134834 A1
(43) Pub. Date: Jun. 9, 2011

(54) Coordinating Broadcast Operations in a Mobile Wireless Network With Overlaid Cells

(76) Inventors: Xiangying Yang, Portland, OR (US); Muthaiah Venkatachalam, Beaverton, OR (US)

(21) Appl. No.: 12/633,853

(22) Filed: Dec. 9, 2009

(51) Int. Cl. H04W 40/00

(52) U.S. Cl. 370/328

(57) ABSTRACT

Advertising in connection with handing off a cell from one cell to another may be facilitated by segregating communication descriptors into a common part that does not change in different types of cells and a unique part that changes in different types of cells. The unique parts may be advertised more frequently than the common parts.

### CROSS-REFERENCE TO RELATED APPLICATIONS

This application is related to provisional application Ser. No. 61/134,188, filed Jul. 7, 2008.

### BACKGROUND

This relates to the management of wireless networks and, particularly, to heterogeneous networks.

A heterogeneous mobile wireless network is a mobile wireless network with different types of cells overlaid within the network. By “overlaid”, it is intended to refer to the coexistence of cells within the same territory. Thus, any given cell may have a territory of a given size, but that same territory is also serviced by another cell.

The term “cell” refers to a combination of at least one mobile station and one base station. The base station includes a wireless transceiver which communicates with any mobile stations within its range. By “range”, it is intended to refer to the distance at which the base station can communicate with mobile stations, that range correlating to the cell size.

The basis for determining cell types is virtually unlimited. As one example, cell types can be classified as macro-cells, pico-cells, relay-cells and femto-cells. In an overlaid network, one macro-cell may have, within its range, a number of pico-cells, relay-cells and femto-cells. A macro-cell has a range which is greater than the range of a relay-cell, a femto-cell or a pico-cell. A macro-cell may be coupled by a wired backbone to a network center. A macro-cell communicates wirelessly with mobile stations within its range, as well as base stations within its range, those base stations being associated with smaller cells within the range of the macro-cell. Generally, macro-cells are open to the public and use a wired, dedicated backhaul from a conventional base station.

A relay-cell uses a wireless backhaul to a macro-cell base station. The relay-cell base station may use the same spectrum for backhaul and access is similar to that used in pico-cells. A relay-cell generally has a smaller range than a macro-cell. A pico-cell may have a smaller range than a macro-cell. For example, in some cases, a macro-cell may have a range on the order of 20 kilometers, while the pico-cell may have a range of 20 meters. The pico-cell uses a lower power base station than a macro-cell with a dedicated backhaul connection. It may be open to public access and generally uses wireless backhaul. A pico-cell may also be called a hot zone. The femto-cell can be treated as a special case of pico-cell with home broadband Internet as backhaul and possibly limited access to only a set of subscribers.

Thus, as a given mobile station moves, for example, within a given macro-cell, it may transition to region serviced solely by the macro-cell base station. That mobile station may transition from such a region to a region handled by one pico-cell to a region handled by another pico-cell to a region handled by a relay-cell, all within the same macro-cell. Thus, the heterogeneous network must deal with hand over problems between cells that are organized and operated in different ways, but which may be overlaid nonetheless.

### BRIEF DESCRIPTION OF THE DRAWINGS

FIG. 1 is a depiction of a heterogeneous mobile wireless network in accordance with one embodiment; and

FIG. 2 is a flow chart for a sequence that may be implemented by a macro-cell, base station or a network operations center, as two examples, in accordance with some embodiments.

### DETAILED DESCRIPTION

The issues arising from broadcasting neighbor list information for handover in heterogeneous wireless networks may be resolved in a way that reduces the overhead associated with different cell characteristics. In some embodiments, grouping may be used to simplify the handling of different cell types. By grouping, it is intended to refer to the practice of determining similarities between cell type operating characteristics and exploiting those characteristics to simplify the hand off from one cell to another in the same group in an overlaid arrangement.

Once cell types have been grouped, representative base stations may be identified whose characteristics may be most representative of that group. At the same time, characteristics of cell types may be segregated so that characteristics can be handled differently. Thus, in some embodiments, cell characteristics that are common among all the grouped cells may be handled differently than cell characteristics that are unique to only one or a small number of cells within a group. As one example, common characteristics may be characteristics that are both common and constant in that they do not change frequently. Common characteristics may be advertised across a heterogeneous network with lower frequency than unique characteristics since a mobile station likely has obtained the common characteristics via previous system information acquisition or provisioning.

A heterogeneous network may use any of a variety of wireless standards, including, but not limited to, WiMAX (IEEE Std. 802.16-2004, IEEE Standard for Local and Metropolitan Area Networks, Part 16: Interface for Fixed Broadband Wireless Access Systems, IEEE New York, N.Y. 10016) and WiFi (IEEE Std. 802.11 (1999-07-015) Wireless LAN Medium Access Control (MAC) and Physical Layer Specifications). It may include personal area networks, metropolitan area networks, and, in fact, networks of any particular size.

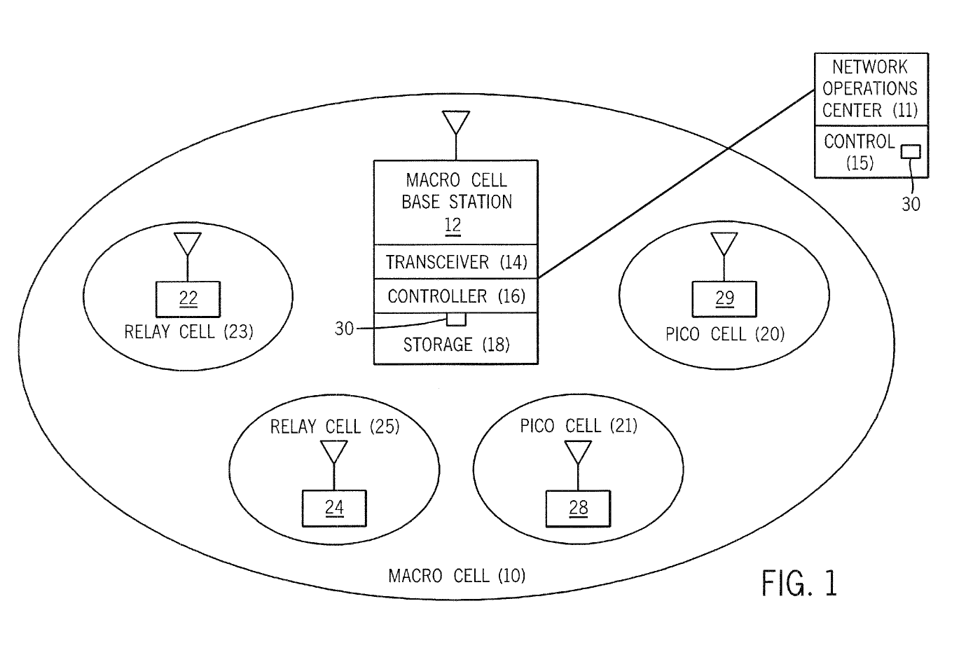

Referring to FIG. 1, a heterogeneous network, in this example, may include a network operations center 11, having a control 15, which implements a sequence 30. The control 15 may be, for example, a computer, such as a server, which operates under the control of instructions stored in a computer readable medium. That computer readable medium may be any type of storage, including an optical, magnetic, or semiconductor storage that stores instructions executed by a processor or computer. The network operations center 11 may communicate over a wired connection to a macro-cell base station 12. In fact, the network operations center 11 may communicate over wired connections to a number of macro-cell base stations.

The macro-cell base station 12 includes a transceiver 14 and a controller 16, which may be processor or computer for executing instructions stored in a computer readable medium, such as a storage 18 that stores the sequence 30, in one embodiment. The macro-cell base station 12 may have a given range indicated by the extent of the macro-cell 10 depiction in FIG. 1. That range may encompass mobile stations. Those mobile stations may transition between areas of the macro-cell 10 covered only by the base station 12 and areas covered by other cells that are overlaid on the macro-cell 10. For example, the pico-cell 20, the pico-cell 21, the relay-cell 25, and the relay-cell 23 are all overlaid on the macro-cell 10. Each relay-cell or pico-cell includes a base station and any mobile stations that come within its range.

Thus, the relay cell 23 has the range as indicated in FIG. 1 and includes a base station 22. The relay-cell 25 has the range indicated and a base station 24. The pico-cell 21 has the range indicated and a base station 28, while the pico-cell 20 has the range indicated and the base station 29. Thus, a mobile station can transition from a region covered only by the macro-cell base station 12 to a region covered by the base station 29 to a region covered by the base station 22.

Because cells may be different and may be of different types, the nature of the broadcast information needed to execute a hand over from cell-to-cell may become complex. Extensive overhead may be involved in keeping track of all the necessary information associated with all neighbors (possible target base stations) provided from a serving base station to a target base station. A serving base station is a base station which was last communicating with the mobile station and a target base station is a base station with which the mobile station is about to communicate next.

As used herein, a common part is that portion of configuration information or a communication descriptor (e.g. downlink communication descriptor (DCD)/uplink communication descriptor (UCD) in IEEE Standard IEEE 802.16e-2001, available from IEEE, New York, N.Y. or Super Frame Header (SFH) in IEEE 802.16m-2005 or System Information Blocks (SIBs) in Long Term Evolution (LTE)), that is the same or substantially the same when two cells are of the same cell type. Again, it should be reiterated that the present invention is not limited to any particular cell type, or any collection of cell types within the heterogeneous network, but applies generally regardless of cell type. Some of the parameters of the common part may be shared across an entire network operations center 11, regardless of cell type. Examples may include carrier frequency, time or frequency division duplex (TDD/FDD) mode.

In some cases, a handover may occur between two base stations of the same cell type with the same physical layer (PHY) configurations. Some common parts, such as carrier frequency, duplex mode, bandwidth, and orthogonal frequency division multiplexing access (OFDMA) symbol structure are not likely to change over time. Mobile stations can assume these common parts may be unchanged, even if they do not get this information in the course of a handover.

When a mobile station transitions from being serviced by a serving base station to a target base station, it may resort to a neighbor advertisement broadcast, which may be broadcast wireless (e.g. by WiMAX) with some periodicity by each base station. Some common parts, such as the downlink/uplink ratio may change from time-to-time, but are common across the network. Fields that are common across the network, even if they change from time-to-time in a relatively long time scale, can be classified as fields shared among all base stations of a particular type within a particular neighbor advertisement message.

Other fields may change across cells and may be defined more carefully. The parts that change across cells may be called the unique part, in that they are unique for each base station or relay station, such that a mobile station does not miss any possible difference in configuration as it is handed off from one base station to another.

The unique part may be encoded in one of at least two encoding formats. Parameters such as hybrid acknowledge repeat request (HARQ) type, hand off (HO) type can be configured independently within each cell. However, the options may be limited and predefined. For example, currently, the HO type, supported by WiMAX, are hard HO, Macro Diversity (MD) HO, Fast Base Station Switching (FESS), BS-controlled HO. A four-bit type definition is sufficient to capture these options. The four-bit type definition is an example of a configuration type.

Other parameters, such as ranging code partition, base station maximum receive power, or hand over trigger/action definitions, can be configured independently within each cell and their values are not likely to be captured within a configuration type made up of only a few bits and, moreover, they may be of variable lengths. These parameters may be encoded in type-length-value (TLV) or abstract syntax notation one (ASN.1), (See International Telecommunications Union (ITU) Recommendation X.680 (07/02), available from the ITU, Geneva, Switzerland) encoding, in some embodiments. Of course, other parameters and encoding formats may be used in some embodiments. In addition, a base station or the network operations center 11 may determine which encoding scheme is best for each parameter in a given implementation.

Thus, to summarize, the parts of the system configuration parameters included within a neighbor advertisement broadcast are the common part and the unique part. The common part is cell type specific or deployment specific. The unique part may include a configuration type which is cell type specific and other types which, in some embodiments, may be encoded using TLV encoding.

In accordance with one embodiment, the neighbor advertisement broadcast (NBR-ADV) format may be as follows:

```
NBR-ADV
{
    [Common part (shared by the network)]
    For [cell-type] = 1:m  Loop by cell types allows compression
    {
        [Common_part (cell specific)] Non-TLV configuration fields
        For BS_index = 1 to k
        {
            BS-ID
            [configuration type];
            other configuration info in TLV;
        }
    }
}
```

Base stations may first be grouped according to their cell type. Within each cell type, common parts can be captured by a shared or common part field or indicated by a cell type specific configuration type. The unique part for each base station or relay station may be encoded in type length value fields or other predefined format. The neighbor advertisement broadcasts format compresses the overhead by removing redundancies existing among base stations belonging to the cell type.

Because the unique part for base stations belonging to the same cell type may share many common values, the neighbor advertisement broadcasts may only indicate the delta partition from a representative base station. The techniques for picking the representative base station may enable the most efficient compression. The techniques may be implemented by the network operations center 11 or the macro-cell base station 12, as two examples. For example, when there are six relay cells and one of those six is using a very different configuration than the other five, which share the same configuration, it would make sense to pick one of the five as the representative base station (BS₁) for the neighbor advertisement broadcast:

```
NBR-ADV
{
    [Common part (shared by the network)]
    For cell-type = 0:m
    {
        [common part (cell specific)] Loop by cell types allows
        compression
        //A typical BS in this cell type Non-TLV configuration fields
            BS_index = 1
        {
            BS-ID
            cell-type specific [configuration type];
            other configuration info in TLV;
        }
        //other BS in this cell type
        For BS_index = 2 to k
        {
        BS-ID
        Cell-type specific [configuration type];  More compression
        Delta system information(from BS₁ TLV);  when
Configuration TLVs are almost the same
        }
    }
}
```

Based on the partition of the neighbor advertisement broadcast messages, a base station can adaptively broadcast unique and common parts at different intervals. The rules for broadcasting a neighbor advertisement may balance signaling overhead and hand over delay performance. For example, the base station may broadcast the common parts with a larger interval to reduce overhead without compromising functionality, in some embodiments. The base station may broadcast the unique parts more frequently with shorter intervals to allow the mobile stations to obtain enough necessary information for handover more quickly.

In some embodiments, the base station may broadcast a version number. For example, one version number may be used for a network-wide common part and one version number may be used for cell types specific for common part. The version number may be broadcast at the shorter interval, along with the unique part. A mobile station may be trusted to make sure that the cached common part is valid. A base station may immediately broadcast a unique part when changes happen or when notified by a neighboring base station from backbone communications. This may help the mobile stations that are likely to perform handover to obtain the up-to-date information of a candidate target base station.

A benefit of reducing handover delay, in some embodiments, comes from the shorter intervals in broadcasting the unique part. Mobile stations can reconstruct the whole system configuration information of any neighbor base station with a previously received common part. The HO preparation latency can thus be reduced in some embodiments. The overhead may also be well maintained even when the unique part is broadcast much more frequently.

The neighbor advertisement broadcast is slightly more complicated in an overlaid network with heterogeneous cell types. The broadcast pattern, in such case, may depend on the cell types of the serving and target base stations and network topology. In one scenario, if the serving base station and target base station are of the same cell type, there may be no need to broadcast the common part at all for currently connected mobile stations. Because the common part is the same for the serving and target base stations, the mobile stations can readily reconstruct the whole neighbor base station's system configuration information by combining the unique part of the neighbor advertisement broadcast and the common part from the serving base station's own system information broadcast.

If the serving and target base stations are of different cell types, the common part may be broadcast, but at lower frequency. Mobile stations that have a history of the common part for a cell type different from the serving base stations can quickly combine a unique part to construct an up-to-date system configuration information for a neighboring base station. If not, they can wait until the common and unique parts are available, which defines a worst case scenario.

An adaptive neighbor advertisement broadcast may also use different broadcast frequency for different cell types. Because the target base stations may be sorted by type, the serving base station can choose to broadcast system configuration of macro-cells more frequently than those, say of smaller cells, such as pico-cells. For many mobile stations, handover to a macro-cell is the most likely scenario and involves small latency compared to the case of the handover from a macro-cell to a pico-cell, which typically is for load balancing and capacity and which may not be as time critical as the handover to a macro-cell. Such an approach to prioritizing types of target base stations may reduce handover preparation latency in some embodiments.

As an example, without limitation with respect to the scope of the present invention, the common part may contain those fields that are common at any given time within the cell of the same cell type. As shown in Table 2 below, it may be either a predefined type, for example, a two bit type representative of a particular choice from a set of possible common part values, or it may be the actual value itself, such as an eight bit value for carrier frequency. Note, some of the fields in the common part may be changed from time-to-time, such as the downlink/uplink ratio, to adapt to load dynamics. However, these types of changes happen across the whole network since synchronization of all uplink and downlink sub-frames may be desirable to reduce interference.

| | Length | |
|---|---|---|
| Name | bits | Note |
| Carrier | 48 (may | e.g., 700M, 2.4 G, |
| freq | be 8 bit | 3.5 G depending on |
| | if type | operator spectrum |
| | encoded) | |
| Bandwidth | 2 | 5M, 10M, 20M |
| | | in the 16m SDD |
| CP | 2 | 1/32 1/16 ⅛ ¼ |
| DL/UL | 8 | Bitmap indicating the |
| ratio | | DL/UL of up to 8 subframes |

The configuration type used in the unique part is a predefined type number corresponding to a set of configurations from a profile. The configuration type may have limited options, yet each base station or relay station may pick different options in the same deployment. A configuration type definition may be built into the mobile station such that whenever the mobile station receives a configuration type, it looks up the values for the associated field that this represents:

| | Length | |
|---|---|---|
| Name | bits | Note |
| TTG | 16 | Depending on the time granularity defined |
| RTG | 8 | |
| HARQ | 6 | Sync/Unsync; Adaptive/Non-Adaptive; CC/IR; |
| PHY rev | 3 | 802.16d. 802.16e. 802.16e-rev2. 802.16m. |
| MAC rev | 3 | |
| HO type | 4 | Hard HO. MD HO. FBSS. BS-controlled HO. |
| Relay | 3 | (Relay Station only) Cooperative transmission, |
| capability | | spatial reuse, transparent relay, non-transparent |
| | | relay, etc. |

The parameters in the unique part may be encoded, in some embodiments, using TLV. For purposes of reducing overhead and broadcasting redundant information, the unique and common parts of the system configuration information may be defined under the assumption of a typical deployment scenario. The fields listed below may be included in the unique part. The unique part may be either TLV encoded or in fixed/predefined fields, as another example. One benefit of using TLV is that there is flexibility to determine which type to include in each broadcast, at the cost of adding extra overhead to indicate type and length. Therefore, TLV may enable only inserting delta information when a group of base stations are similarly configured.

| Name | Type (byte) | Length bits | Note |
|---|---|---|---|
| Burst_Profile | TBD | variable | May also be tied |
| | | | with cell type as |
| | | | a common part |
| EIRx | TED | 8 | |
| Ranging code | TED | TED | Initial ranging, |
| assignment | | | periodic ranging, |
| | | | handover ranging, |
| | | | etc. |
| Trigger/Action | TED | variable | Various actions MS |
| | | | should follow if |
| | | | trigger value is met |
| Cell load | TBD | 4~8 | Help MS to make |
| | | | handover decision |
| | | | for load balancing |

In some embodiments, a neighbor advertisement broadcast may be used in mobile wireless networks that are heterogeneous or non-heterogeneous. By broadcasting the neighbor advertisement messages periodically, a serving base station provides the information and network topology and neighbor base station configuration to mobile stations in its cell. Obtaining the neighbor advertisement broadcast message may ensure optimized handover and mobility management in some embodiments.

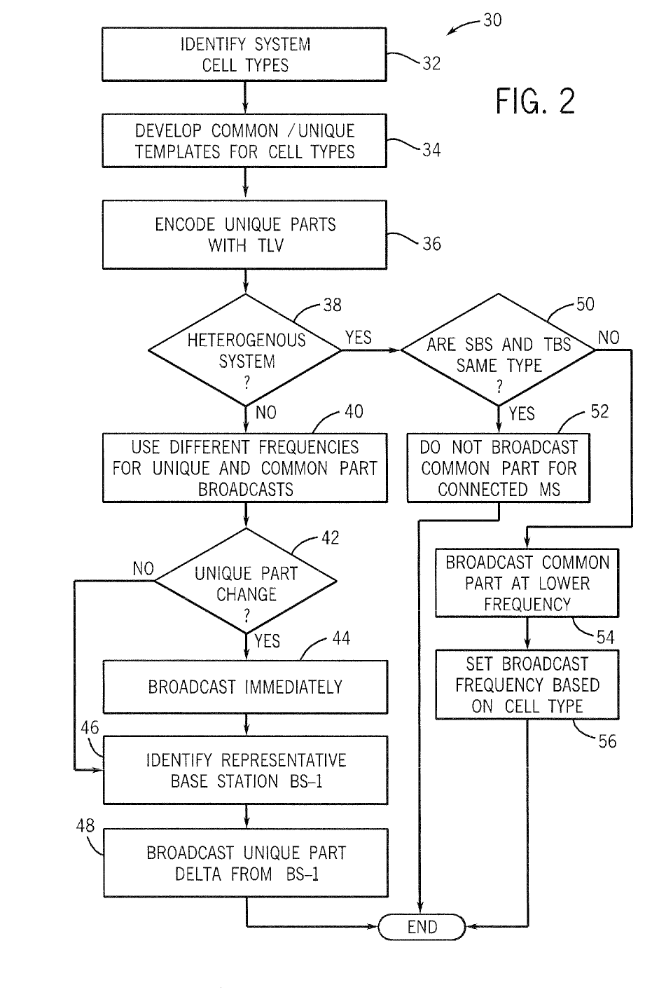

Referring to FIG. 2, in accordance with one embodiment, the sequence 30 may be stored within the control 15 of the network operations center 11, as shown in FIG. 1, or in a macro-cell base station 12, as indicated at 30, in the storage 18. The sequence may be implemented in software, hardware, or firmware, however. Initially, in the sequence, the system cell types are identified, as indicated at block 32. Then the common and unique templates are developed for each cell type, as indicated in block 34.

In one embodiment, unique types may be encoded using TLV, as indicated in block 36.

A check at diamond 38 determines whether the system is heterogeneous or not. If not, different broadcast frequencies may be used for unique and common part broadcasts, as indicated at block 40, and as already described. A check at diamond 42 determines when a unique part has changed. When it changes, it may be broadcast immediately, as indicated at block 44. In addition, in block 46, a representative base station may be identified, as described above. The unique part delta from the representative base station may then be broadcast, as indicated in block 48.

When the system is not heterogeneous, a check at diamond 50 determines whether the sending (SBS) and target (TBS) base stations are the same type. If so, the common part is not broadcast for connected mobile stations, as indicated in block 52.

If the sending and target base stations are not the same type as determined in diamond 50, then the common part may be broadcast at a lower frequency than the unique part, as indicated in block 54. The broadcast frequency may be determined based on cell type, as indicated in block 56.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying a set of base stations that are of the same cell type for advertising;
segregating a communication descriptor into a common part that does not change in different types of cells and a unique part that changes in different types of cells; and
advertising the unique part and common part with different periodicities.

2. The method of claim 1 including encoding the unique part using type-length-value or abstract syntax notation one encoding to indicate parameter values.

3. The method of claim 1 including using indication bits to refer to pre-configured type definition.

4. The method of claim 1 including determining a representative base station for a plurality of cells of the same cell type.

5. The method of claim 4 including advertising only the difference between a base station and a representative base station.

6. The method of claim 1 including advertising a version number for a common part.

7. The method of claim 1 including immediately broadcasting changes to the unique part.

8. The method of claim 1 including advertising common parts for target base stations only when a mobile station was not previously connected, if the serving and target base stations are of the same type.

9. The method of claim 1 including changing the advertising frequency based on cell type.

10. The method of claim 9 including advertising with greater frequency for cells with a larger range than for cells with a smaller range.

11. A computer readable medium storing instructions executed by a computer to:
identify a set of base stations that are of the same cell type for advertising;
segregate a communication descriptor into a common part that does not change across different types of cells and a unique part that changes in different types of cells; and
advertise the unique part more frequently than the common part.

12. The medium of claim 11 further storing instructions to determine a representative base station for a plurality of cells of the same type.

13. The medium of claim 12 further storing instructions to advertise only the difference between a base station and the representative base station.

14. The medium of claim 11 further storing instructions to advertise common parts for target base stations only when a mobile station was not previously connected, if the serving and target base stations are of the same type.

15. The medium of claim 11 further storing instructions to change the advertising frequency based on cell type.

16. An apparatus comprising:
a control; and
a storage storing instructions to identify a set of base stations that are of the same cell type for advertising, segregate a communication descriptor into a common part that does not change in different types of cells and a unique part that changes in different types of cells, and advertise the unique part more frequently than the common part.

17. The apparatus of claim 16 wherein said apparatus is a macro-cell base station.

18. The apparatus of claim 16 wherein said apparatus is a network operation center.

19. The apparatus of claim 16, said control to identify a representative base station for a plurality of cells of the same cell type.

20. The apparatus of claim 19, said control to advertise only the difference between a base station and a representative base station.
